(19) United States
(12) Patent Application Publication
(10) Pub. No.: US 2010/0209022 A1
(43) Pub. Date: Aug. 19, 2010

(54) ULTRASONIC DOUBLE FOLD SEAL

(76) Inventors: Keith C. Gilmore, Clay Center, KS (US); Justin D. McDonald, Clay Center, KS (US)

Correspondence Address: HOVEY WILLIAMS LLP, 10801 Mastin Blvd., Suite 1000, Overland Park, KS, 66210, US

(21) Appl. No.: 12/543,255

(22) Filed: Aug. 18, 2009

Related U.S. Application Data
(60) Provisional application No. 61/089,826, filed on Aug. 18, 2008.

(51) Int. Cl. B65D 30/04; B65D 30/10; B65D 30/20; B31B 1/64; B31B 1/62; B31B 37/60

(52) U.S. Cl. 383/94; 383/126; 383/120; 493/199; 493/245

(57) ABSTRACT

A double fold seal having an ultrasonic stitch is provided as a closure means for a bag formed from synthetic resin material, and especially a woven synthetic resin material. A transverse heat seal is created using an ultrasonic welder, for example, and at least two flaps formed outboard from the seal. The flaps are folded over one of the bag panels and ultimately over the heat seal so as to create a bag closure that is strong and leak resistant.

### RELATED APPLICATION

The present application claims the benefit of U.S. Provisional Patent Application No. 61/089,826, filed Aug. 18, 2008, and is incorporated by reference herein in its entirety.

### BACKGROUND OF THE INVENTION

1. Field of the Invention

The present invention is generally directed toward a strong, durable seal at the end of a single-wall polywoven bag. Particularly, the seal comprises a double fold seal with an ultrasonic stitch. This method of bag closure assists in stopping leaks in the corners of the bag folded areas, reduces stress placed on the ultrasonic stitch, and is readily automated.

2. Description of the Prior Art

The use of bags made from synthetic resin material, and particularly woven synthetic resin material (i.e. “polywoven” material), has become increasingly popular. However, providing an effective, yet cost efficient, closure for these types of bags has proven a challenge. Polywoven bags can be manufactured that exhibit excellent tensile strength qualities making them very suitable for containing a wide variety of materials. However, the pliability of these bags does not readily lend itself to conventional types of closures such as might be used with conventional paper or non-woven bags. Conventional folded closures are prone to develop leaks in the corners of the bag folds. Another common closure for polywoven bags is a sewn closure. These closures can be strong, but are can be expensive and time consuming to create. Further, if the sewing is not done properly, leaks can occur at the closure edges.

U.S. Pat. No. 4,498,192 discloses a bag having an overlapped closure and method of fabricating the same. However, the disclosure is limited to bags comprising at least one paper ply, and no mention is made regarding the use of polywoven bags.

U.S. Patent Application Publication No. 2007/0274614 discloses a polywoven bag having a double fold closure. However, the double fold closure described can be prone to leaking near the corners of the bag folds, especially when fine particulate matter is being placed in the bag.

### SUMMARY OF THE INVENTION

In one embodiment of the present invention there is provided a bag comprising opposed first and second panels made from a synthetic resin material. Each of the panels has an inner face, an outer face, opposed end margins, and opposed side margins. The side margins of the first panel are interconnected with the adjacent side margins of the second panel by at least a pair of longitudinally extending segments. The bag further comprises a first bag closure including a transversely extending seal securing together respective portions of the inner faces of the panels. The seal defines a fillable portion and a closure portion of the bag. A pair of slits are located in the longitudinally extending segments on the closure portion. Each of the slits begin adjacent one end margin of one of the panels and extend toward the seal. The slits define first and second marginal flaps in the closure portion. Each of the flaps have inner and outer faces corresponding with the inner and outer faces of the panels. The first flap is double-folded upon the first panel such that the outer face of the first flap engages the first panel at a first region within the closure portion and the inner face of the first flap engages the first panel at a second region within the fillable portion. The second flap is folded over the first flap and secured to the first panel such that the inner face of the second flap engages the first panel at a third region within the fillable portion.

In another embodiment according to the present invention there is provided a method of forming a bag. A tubular body is provided comprising a synthetic resin material and includes opposed first and second panels. Each of the panels has an inner face, an outer face, opposed end margins, and opposed side margins. The side margins of the first panel being interconnected with the adjacent side margins of the second panel by at least a pair of longitudinally extending segments. A seal is created between the inner faces of the panels. The seal extends transversely across both panels between respective panel side margins. The seal defines a fillable portion and a closure portion of the bag. A pair of slits are formed in the longitudinally extending segments of the closure portion. Each of the slits begin adjacent one end margin of one of the panels and extend toward the seal. The slits define first and second marginal flaps within the closure portion. Each of the flaps have inner and outer faces corresponding with the inner and outer faces of the panels. The first flap is folded upon the first panel such that the outer face of the first flap engages the first panel at a first region within the closure portion. The second flap is folded over the first flap such that the inner face of the first flap engages the first panel at a second region within the fillable portion, and such that the inner face of the second flap engages the first panel at a third region within the fillable portion. The second flap is secured to the first panel at the third region.

### BRIEF DESCRIPTION OF THE DRAWINGS

FIG. 1 is a view of an exemplary polywoven bag comprising closures made in accordance with the present invention;

FIG. 2 is a view of a tubular polywoven body having gussets formed therein and the creation of a heat seal proximate one end thereof;

FIG. 3 is a view of the creation of a first fold in the bag closure;

FIG. 4 is a view of the bag closure following the first fold and beginning of the second fold;

FIG. 5 is a view of the bag closure following the second fold; and

FIG. 6 is a view of the bag closure following securing of the second flap to the bag panel.

### DETAILED DESCRIPTION OF THE INVENTION

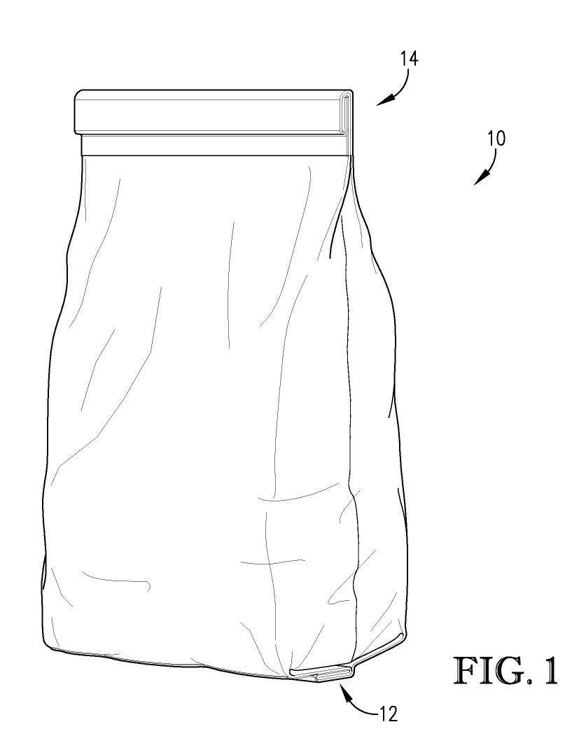

Turning now to FIG. 1, a bag 10 made in accordance with the present invention is shown. Bag 10 is shown sealed at both ends with a pair of closures 12, 14 that are described in greater detail below. Note that is within the scope of the present invention for bag 10 to comprise only one closure made as described hereunder with the second closure being of a conventional type, such as a sewn closure, a folded closure, or the like. In certain embodiments, bag 10 comprises a woven, synthetic resin material, such as polypropylene, and is referred to herein as a “polywoven” bag. In particular embodiments, the polywoven bag is of a single-wall construction, however, it is within the scope of the present invention to construct bags having multi-ply walls and walls comprising materials other than the woven synthetic resin material.

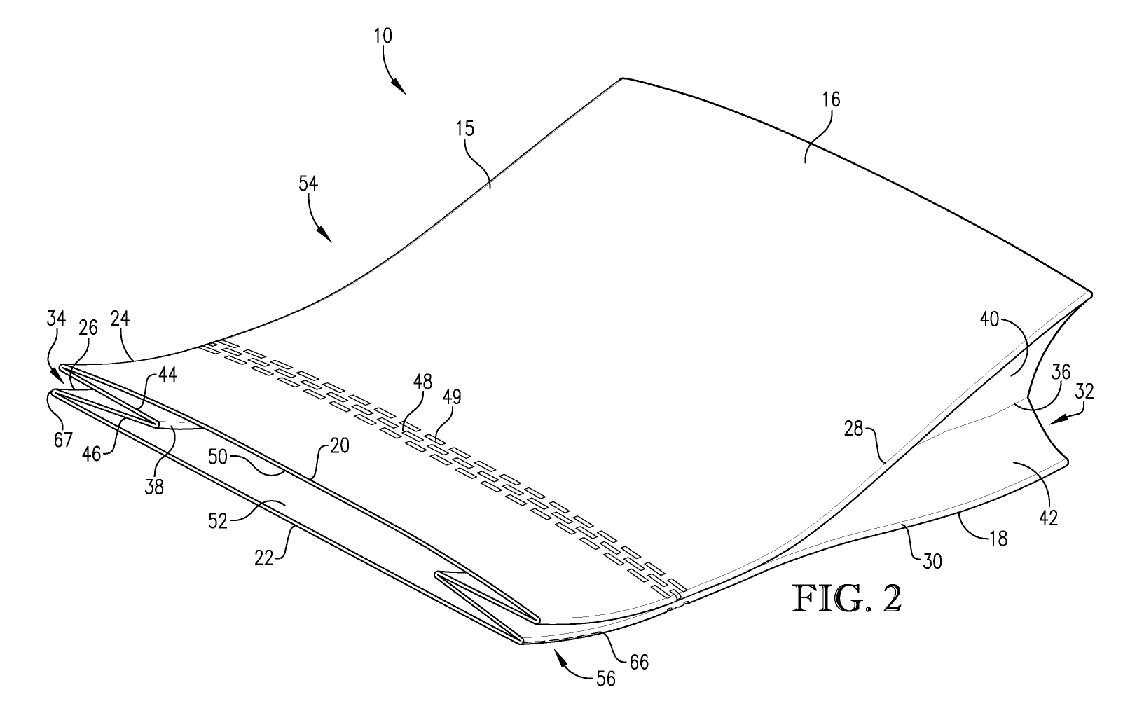

As illustrated in FIG. 2, bag 10 comprises a tubular body 15 that may be folded so as to present a pair of opposed panels 16, 18 including end margins 20, 22, and side margins 24-30. The adjacent side margins of panels 16 and 18 are interconnected by at least a pair of longitudinally extending segments 32, 34. In the embodiments illustrated, segments 32 and 34 comprise respective gusset panels 36, 38 each including a pair of interconnecting subpanels 40-46. Subpanels 40 and 44 are secured to panel 16, and subpanels 42 and 46 are secured to panel 18. It is contemplated that bag 10 may be formed without gussets and that respective end margins of panels 16, 18 can be directly attached by a longitudinally extending segment which presents itself as a seam or line of attachment.

FIGS. 2-6 illustrate the steps involved in the creation of bag bottom closure 12, and it is understood that the same steps could be performed during the creation of a substantially identical top closure 14. Note, the various panels and gussets are shown slightly expanded so as to more clearly illustrate these features. First, a seal 48 is created proximate one end of bag 10, and spaced from end margins 20 and 22. In certain embodiments, seal 48 is a heat seal or an ultrasonic seal that is created, for example, by an ultrasonic welder, that melts small co-linear portions of the inner faces 50, 52 of panels 16, 18, respectively, thereby securing the faces of the panels together. In particular embodiments, seal 48 comprises a plurality of discreet conjoined segments 49 of the inner faces 50, 52 of panels 16, 18. Collectively, segments 49 form what appears to be stitching, however, no actual threaded or sewn stitch is used in the present closure. Depending upon the ultrasonic welding device used, the sealing rate typically ranges from about 40 to 60 feet per minute with an average operating temperature ranging from about 175 to 350° F. Seal 48 extends transversely across panels 16, 18, and in certain embodiments the entire length between respective panel end margins 24-30. If a gusseted bag is being made, gusset panels 36 and 38 are also included in seal 48, sandwiched in between portions of panels 16 and 18. Seal 48 also defines a fillable portion 54 of the bag that can receive the desired contents to be placed therein and a closure portion 56 that will be used to create various flaps and folds which comprise closure 12. When viewed completely laid out as in FIG. 2, finable portion 54 is located inboard and closure portion 56 is located outboard of seal 48.

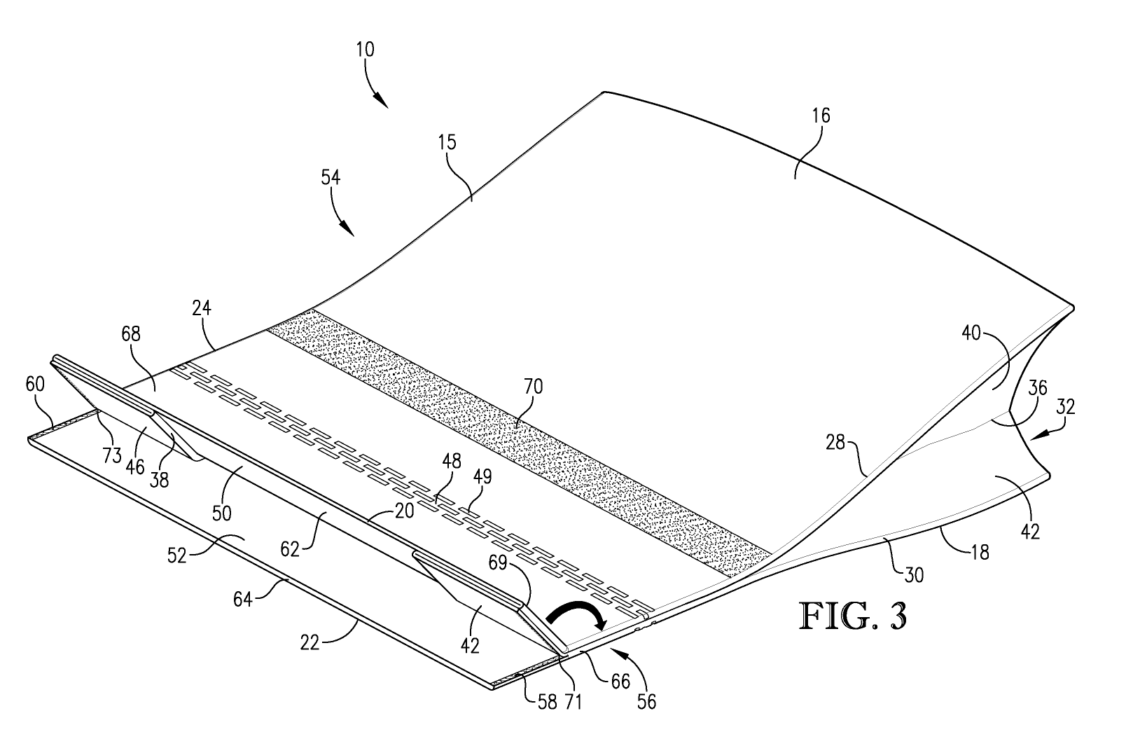

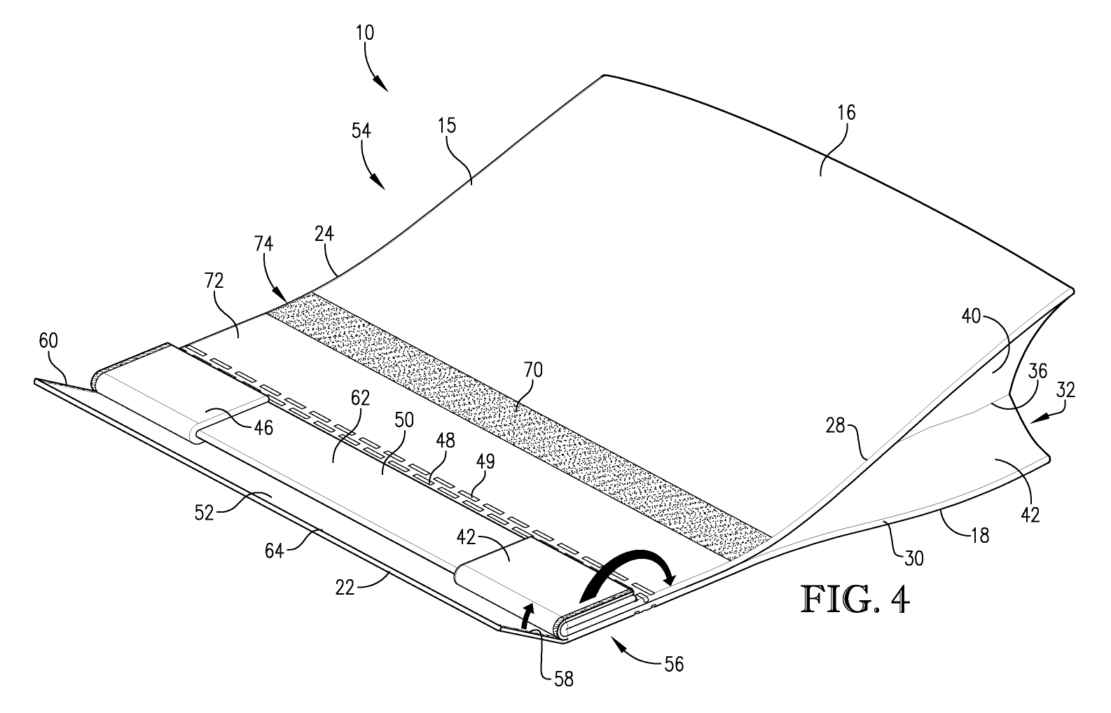

As shown in FIG. 3, slits 58, 60 are cut in segments 32, 34, respectively so as to define marginal flaps 62, 64. Each slit 58, 60 begins adjacent end margin 22 and extends toward seal 48 a predetermined length along a portion of a corresponding juncture line 66, 67 between panel 18 and subpanel 42, 46 of gusset panel 36, 38, respectively. In certain embodiments, the length of the slits 58, 60 is approximately half the length between end margin 22 and seal 48. Flap 62 comprises marginal, transversely extending portions of panel 16 and gusset panels 36 and 38, and flap 64 comprises a transversely extending portion of panel 18 and is defined at its lateral ends by slits 58, 60. In a first fold, flap 62 is folded upon panel 16 such that the outer face 69 of flap 62 engages panel 16, and particularly the outer face thereof, at a first region 68 within closure portion 56. The first fold occurs about a transverse axis that extends substantially between the slit termination points 71, 73. As shown in FIG. 4, end margin 20 is now positioned adjacent seal 48. A line of adhesive 70, such as a hot melt adhesive, is laid down on the outer face of panel 16 within fillable portion 54. Typically, line of adhesive 70 presents a width of between about 1 to 2 inches and is located several inches inboard from seal 48.

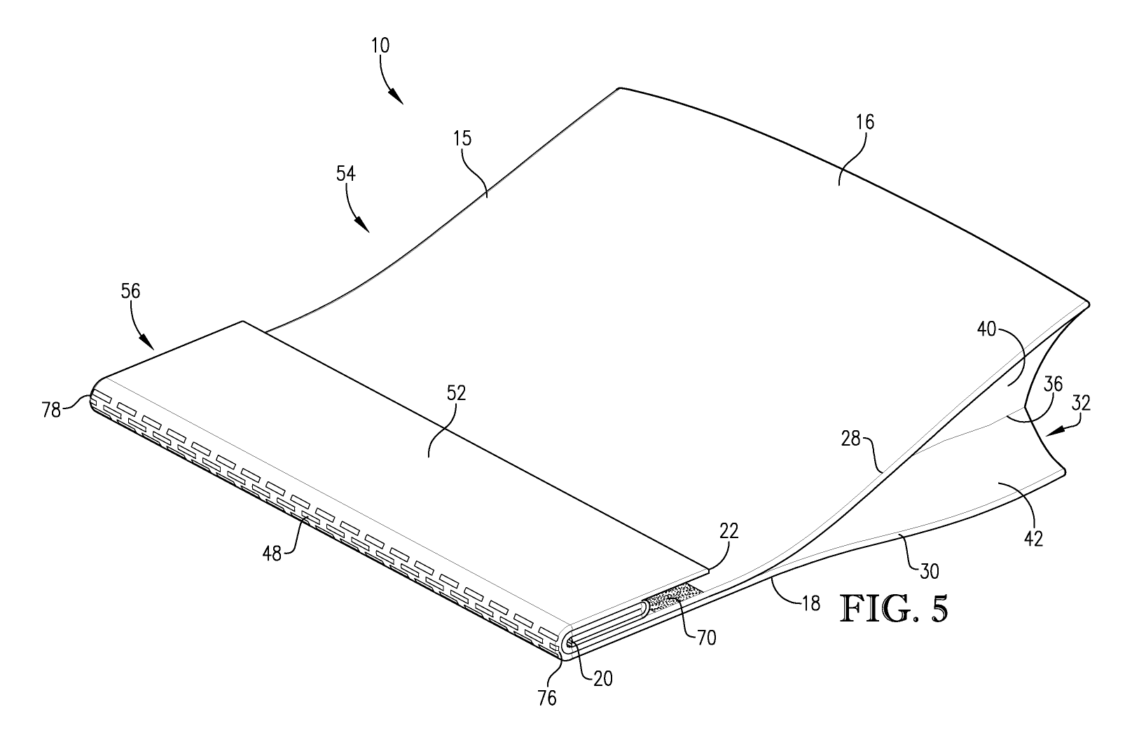

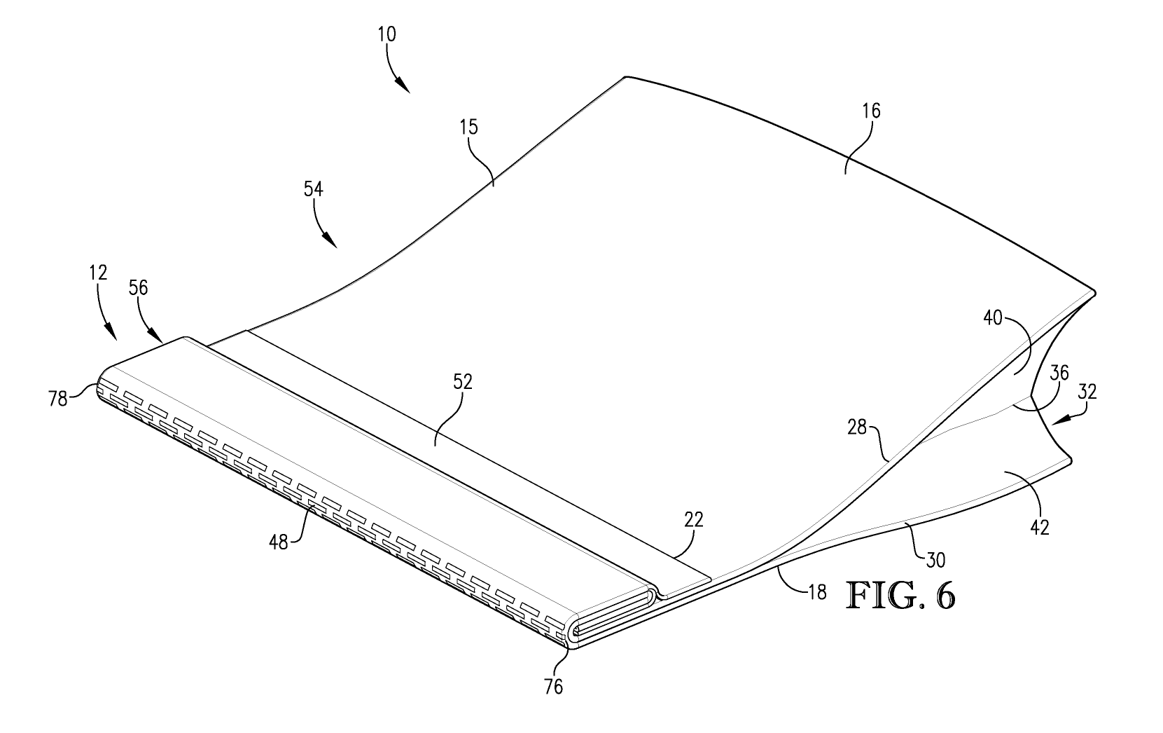

A second fold is created by folding flap 64, and consequently flap 62, such that inner face 50 of flap 62 engages panel 16 at a second region 72 and the inner face 52 of flap 64 engages the outer face of panel 16 at a third region 74, with both regions 72 and 74 being within fillable portion 54. FIG. 5 illustrates this final fold which occurs about an axis between seal end points 76, 78. Thus, the portion of seal 48 formed in panel 16 is buried within the folds of closure 12 so as to eliminate leaks that may occur in the corners around seal 48 and reduce stress on seal 48 upon filling of bag 10. The portion of seal 48 formed in panel 18 is visible on the exterior of bag 10. The inner face of flap 64 is secured to line of adhesive 70 as shown in FIG. 6 thereby completing closure 12.

Upon securing of flap 64 to line of adhesive 70, bag 10 is ready for filling. Bag 10 may be manufactured in any number of desired dimensions such as bags having widths that range from about 8-24 inches and lengths from about 16-48 inches.

We claim:

1. A bag comprising:
opposed first and second panels comprising a synthetic resin material, each of said panels having an inner face, an outer face, opposed end margins, and opposed side margins, the side margins of said first panel being interconnected with the adjacent side margins of the second panel by at least a pair of longitudinally extending segments; and
a first bag closure including—
a transversely extending seal securing together respective portions of the inner faces of said panels, said seal defining a fillable portion and a closure portion of said bag;
a pair of slits located in the longitudinally extending segments on said closure portion, each of said slits beginning adjacent one end margin of one of said panels and extending toward said seal, said slits defining first and second marginal flaps in said closure portion, each of said flaps having inner and outer faces corresponding with the inner and outer faces of said panels,
said first flap being double-folded upon said first panel such that said outer face of said first flap engages said first panel at a first region within said closure portion and said inner face of said first flap engaging said first panel at a second region within said fillable portion,
said second flap being folded over said first flap and secured to said first panel such that said inner face of said second flap engages said first panel at a third region within said fillable portion.

2. The bag according to claim 1, said longitudinally extending segments comprising respective gusset panels each including a pair of interconnecting subpanels, said subpanels being secured to said first and second panels.

3. The bag according to claim 2, each of said slits being located substantially at and along the length of a portion of a corresponding juncture line between said second panel and the adjacent subpanels of said gusset panels, said first flap including marginal, transversely extending portions of said first panel and said gusset panels, said second flap extending between and being defined at its lateral ends by said slits and comprising the transversely extending end margin of said second panel.

4. The bag according to claim 1, said seal comprising a heat seal.

5. The bag according to claim 4, said heat seal comprising a plurality of discrete conjoined segments of the inner faces of said first and second panels.

6. The bag according to claim 1, said inner face of said second flap being secured to said third region with an adhesive.

7. The bag according to claim 1, further comprising a second bag closure located proximate the first and second panel end margins opposite from said first bag closure.

8. The bag according to claim 7, said second bag closure being substantially identical to said first bag closure.

9. A method of forming a bag comprising:
providing a tubular body comprising a synthetic resin material and including opposed first and second panels, each of said panels having an inner face, an outer face, opposed end margins, and opposed side margins, the side margins of said first panel being interconnected with the adjacent side margins of the second panel by at least a pair of longitudinally extending segments;
creating a seal between the inner faces of said panels, said seal extending transversely across both panels between respective panel side margins, said seal defining a fillable portion and a closure portion of said bag;
forming a pair of slits in said longitudinally extending segments of said closure portion, each of said slits beginning adjacent one end margin of one of said panels and extending toward said seal, said slits defining first and second marginal flaps within said closure portion, each of said flaps having inner and outer faces corresponding with the inner and outer faces of said panels,
folding said first flap upon said first panel such that said outer face of said first flap engages said first panel at a first region within said closure portion;
folding said second flap over said first flap such that said inner face of said first flap engages said first panel at a second region within said fillable portion, and such that said inner face of said second flap engages said first panel at a third region within said fillable portion; and
securing said second flap to said first panel at said third region.

10. The method according to claim 9, said longitudinally extending segments comprising respective gusset panels each including a pair of interconnecting subpanels, said subpanels being secured to said first and second panels.

11. The method according to claim 10, each of said slits being located substantially at and along the length of a portion of a corresponding juncture line between said second panel and the adjacent subpanels of said gusset panels, said first flap including marginal, transversely extending portions of said first panel and said gusset panels, said second flap extending between and being defined at its lateral ends by said slits and comprising the transversely extending end margin of said second panel.

12. The method according to claim 9, said seal-creation step comprising melting discrete segments of the inner faces of said first and second panels together so as to permanently join said inner faces together.

13. The method according to claim 12, said seal-creation step comprising the use of an ultrasonic welder.

14. The method according to claim 9, further comprising the step of applying an adhesive to at least a portion of the third region prior to folding said second flap over said first flap.
